(19) United States
(12) Patent Application Publication
(10) Pub. No.: US 2021/0194058 A1
(43) Pub. Date: Jun. 24, 2021

(54) NONAQUEOUS ELECTROLYTE LIQUID BATTERY

(71) Applicant: MAXELL HOLDINGS, LTD., Otokuni-gun, Kyoto (JP)

(72) Inventors: Tomohito Sekiya, Otokuni-gun (JP); Masayuki Yamada, Otokuni-gun (JP); Yasunori Masaoka, Otokuni-gun (JP); Yoshihisa Hirose, Otokuni-gun (JP); Atsushi Hatakeyama, Otokuni-gun (JP); Hidetoshi Morikami, Otokuni-gun (JP)

(73) Assignee: MAXELL HOLDINGS, LTD., Otokuni-gun, Kyoto (JP)

(21) Appl. No.: 16/075,941

(22) PCT Filed: Jan. 26, 2017
(86) PCT No.: PCT/JP2017/002682

§ 371 Date: Aug. 6, 2018

(30) Foreign Application Priority Data
Feb. 9, 2016 (JP) 2016-023021
Feb. 29, 2016 (JP) 2016-037531

(51) Int. Cl. H01M 10/0569; H01M 4/525; H01M 4/505

(52) U.S. Cl. CPC H01M 10/0569; H01M 2004/027; H01M 4/505; H01M 4/525

(57) ABSTRACT

The nonaqueous electrolyte battery has good storage characteristics in a high temperature environment. The inventive nonaqueous electrolyte battery includes: an electrode body that is obtained by laminating a positive electrode and a negative electrode with a separator in between; a nonaqueous electrolyte solution that contains a lithium salt and an organic solvent. The inventive nonaqueous electrolyte battery is characterized in that the positive electrode includes a lithium-containing layered nickel oxide that contains 50% by mole or more of Ni relative to Li; that the negative electrode includes a laminate that contains a metal base layer which is not alloyed with Li, and an Al active layer that is bonded to one surface or both surfaces of the metal base layer; and that a Li—Al alloy is formed on at least the surface side of the Al active layer.

### TECHNICAL FIELD

The present invention relates to a nonaqueous electrolyte liquid battery having good storage properties.

### BACKGROUND OF THE INVENTION

Nonaqueous electrolyte liquid batteries are used in various fields of use due to characteristics such as high capacity and high voltage. Particularly in recent years, the demand of nonaqueous electrolyte liquid batteries is prolonging for the apparatus of vehicle installation.

Conventionally, the power supply of electronic equipment for vehicle installation has been a nonaqueous electrolyte liquid primary battery which has storage properties better than generally used nonaqueous electrolyte liquid secondary batteries and hardly decreases its capacity even after its storage for a long term of multiple years.

In the nonaqueous electrolyte liquid primary batteries, lithium metal or lithium alloys such as Li—Al (lithium aluminum) alloys are used as the negative electrode active material. Also in the nonaqueous electrolyte liquid secondary batteries, the lithium alloy can be used as the negative electrode active material. There have been proposals to provide a clad material in which a metal that is capable of absorbing and desorbing lithium and another metal that does not have an ability to absorb and desorb the lithium are used to constitute a negative electrode, thereby realizing the stabilization of the battery characteristics (see Patent Reference No. 1 and No. 2).

### PRIOR ART REFERENCES

### Patent References

Patent Reference No. 1: Japanese Laid-Open Patent Publication No. 8-293302; Patent Reference No. 2: Japanese Laid-Open Patent Publication No. 10-106628

### SUMMARY OF THE INVENTION

### The Objectives to Solve By the Invention

On the other hand, use of such a clad material as described above does not necessarily accomplish the stabilization of the characteristics of the nonaqueous electrolyte liquid secondary battery.

The present invention was accomplished in view of the circumstances above, and therefore, the present invention provides a nonaqueous electrolyte liquid battery with good storage properties under a high temperature environment.

### Means to Solve the Problem

Achieving the objectives as described above, the nonaqueous electrolyte liquid battery of the present invention includes an electrode body in which a positive electrode and a negative electrode are stacked with an intervention of a separator and a nonaqueous electrolyte liquid including a lithium salt and an organic solvent. The positive electrode includes a lithium-containing nickel layered oxide including 50 mol % or more of Ni with respect to Li. The negative electrode includes a stacked body including a metal base material layer which does not alloy with lithium and an Al activation layer that is joined to one side or both sides of the metal base material layer. At least one surface of the Al activation layer has formed a Li-A alloy.

### Effects of the Invention

According to the present invention, a nonaqueous electrolyte liquid battery having good storage properties under high temperature environments can be provided.

### BRIEF DESCRIPTION OF THE DRAWINGS

FIG. 1 is a cross section schematically showing an example of a negative electrode (a negative electrode precursor) used for the nonaqueous electrolyte liquid battery of the present invention.

FIG. 2 is a plan view schematically showing an example of the nonaqueous electrolyte liquid battery of the present invention.

FIG. 3 is a cross section view at the line I-I of FIG. 2.

### EMBODIMENTS TO CARY OUT THE INVENTION

Li (metal Li) and a Li—Al alloy (an alloy of Li and Al) have a lower accepting feature of Li (Li ion) than carbon material, and therefore, when they are used as a negative electrode active material of a nonaqueous electrolyte liquid secondary battery, the capacity can quickly decrease when repeating charge and discharge. By this reason, in the nonaqueous electrolyte liquid secondary batteries in which charge and discharge are supposed to be repeated, a carbon material such as graphite is generally used as a negative electrode active material.

On the other hand, in a nonaqueous electrolyte liquid secondary battery which uses a carbon material as a negative electrode active material, there is a tendency to generate a self-discharge, and therefore, a capacity drop may easily happen when it is stored at a charge state.

As a result, a battery used in equipment for vehicle installation has been a nonaqueous electrolyte liquid primary battery which has storage properties better than generally used nonaqueous electrolyte liquid secondary batteries and which hardly decreases its capacity even after its storage for a long term of multiple years.

On the other hand, in view of easy maintenance in the use field of this kind, though it is not such a demand to require a number of charge and discharge operations in the same level as a general secondary battery there is still a demand to provide a battery in which it allows to be applicable for several to tens of charge operations.

Therefore, the nonaqueous electrolyte liquid battery of the present invention is intended to provide the following features. That is, even if used under a high temperature environment as used particularly in vehicle installation, it can achieve high storage and high capacity. Also, it can allow a certain member of charge operations. In view of the above, a Li—Al alloy is used as a negative electrode active material.

Also, in the nonaqueous electrolyte liquid battery of the present invention, a current collector is used in order to stabilize the shape of the negative electrode at the time of discharge and enable subsequent charge operation.

By the way, in a battery using a Li—Al alloy in a negative electrode active material, for example, a Li foil (This can include a Li alloy foil unless otherwise noted. The same notion is applicable to the later explanation.) and an Al foil (which can include an Al alloy foil unless otherwise noted. The same notion is applicable to the later explanation.) is laminated with each other and introduced in a battery, and then, a reaction between Li and Al is caused under coexistence of a nonaqueous electrolyte liquid, thereby forming a Li—Al alloy. However, if an additional metal foil to become a current collector [e.g., a Cu (copper) foil or a Cu alloy foil] is just stacked with a stacked body of the Li foil and the Al foil before inserting them inside a battery, the internal resistance of the battery results in an increase after storage (in particular after storage under a high temperature environment), and therefore, a storage characteristic cannot be sufficiently improved.

The inventors of the present application have discovered the followings. A change in volume occurs when Li—Al alloy is formed from a stacked body of a Li foil and an Al foil in a battery; or a change in volume occurs when a Li—Al alloy is formed and fine particles are generated, thereby making the negative electrode easily absorb the nonaqueous electrolyte liquid; and therefore, the coherency between the layer (Al foil) of the Li—Al alloy and the current collector cannot be secured.

Therefore, the inventors of the present application have examined, and found, for example, the followings. There is a first method including the steps of: joining an Al metal layer (e.g., Al foil) to form a Li—Al alloy with a metal base material layer (e.g., Cu foil), which does not alloy with Li, acting as a current collector, further stacking a Li layer (e.g., Li foil) on the surface of the metal layer, and reacting the Li of the Li layer with the Al of the Al metal layer, and alternatively, there is a second method including the steps of: using a joined body of the Al metal layer and the metal base material layer, as it is, in assembling a battery, charging it after the assembling to electrochemically react the Al of the Al metal layer with Li ions in a nonaqueous electrolyte liquid, thereby making a Li—Al alloy at least on a surface side of the Al metal layer, as a result, the first or second method can provide a negative electrode in which an Al activation layer is joined to the surface of the metal base material layer. By the methods above, it was found that an increase of the internal resistance at the time of the storage can be suppressed.

Also, by joining the metal base material layer to the Al metal layer in advance, the negative electrode can be restricted from transforming (e.g., curving) to some extent when the Al activation layer is formed by forming a Li—Al alloy at least on the surface side of the Al metal layer.

Furthermore, in the nonaqueous electrolyte liquid battery of the present invention, a positive electrode is used which includes, as a positive electrode active material, a lithium-containing nickel layered oxide containing 50 mol % or more of Ni with respect to Li.

Regarding the positive electrode active material to be used as a nonaqueous electrolyte liquid battery, a lithium cobalt oxide is generally used. However, in case of a secondary battery using a lithium cobalt oxide as a positive electrode active material, elution of a metal (cobalt) can occur when stored at a high temperature at a charge state. If that happens, the positive electrode active material that can contribute to charge and discharge will be decreased, thereby decreasing a discharge capacity thereafter. Furthermore, a battery will swell when gases are generated upon elution of the metal (cobalt).

However, when a lithium-containing nickel layered oxide containing 50 mol % or more of Ni with respect to Li is used as a positive electrode active material, metal elution can be restricted even at a high temperature in a charged state of battery. As a result, decrease of a discharge capacity and generation of gases due to the metal elution can be restricted.

In this way, the present invention can synergistically function the action of restriction from transforming the negative electrode due to joining the metal base material layer to the Al activation layer, and the action of restriction from generating gases due to using the positive electrode active material, and therefore, can provide a battery whose swollenness is small (i.e., the amount of change in volume is small) even when storing it at a high temperature for a long-term, that is, for example, one month.

As a first method to prepare the negative electrode of the nonaqueous electrolyte liquid battery of the present invention, a metal base material layer which does not alloy with Li (which is hereinafter simply referred to as “base material layer”) is joined to an Al metal layer (which is hereinafter simply referred to as “Al layer”) to form a stacked metal foil. A Li foil is laminated on the surface of the Al layer to form a Li layer. In other words, a stacked body is used in this method.

The base material layer can be made of a metal such as Cu, Ni, Ti and Fe, and an alloy of such an element with another element (it is noted that the alloy should not react with Li, such as stainless steel).

Specifically, the base material layer can be formed by a foil, a vapor deposited film or a plating film of the metal or alloy.

The Al layer can be formed by pure Al or an Al alloy including an additional element for the purpose of improving, e.g., strength. Specifically, the Al layer can be formed by a foil, a vapor deposited film or a plating film of such pure Al or Al alloy.

In order to form the Li layer, there can adopt a method to laminate a Li foil to the surface of the Al layer, or a method to form a vapor deposited film.

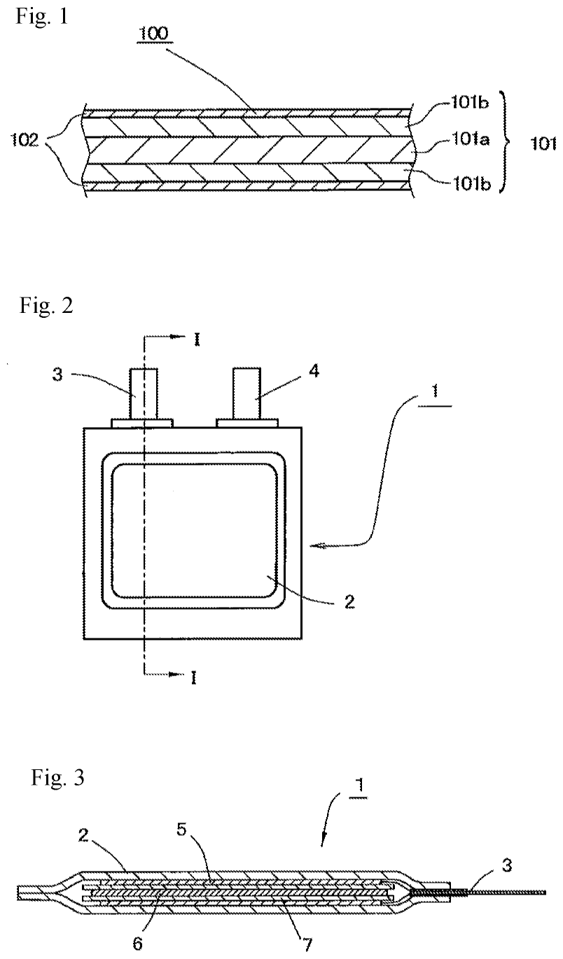

FIG. 1 shows a cross section schematically showing an example of a stacked body to form a negative electrode (a negative electrode precursor) used for the nonaqueous electrolyte liquid battery of the present invention. In the negative electrode precursor 100 of FIG. 1, Al layers 101b, 101b are joined to both sides of the base material layer 101a to form a stacked metal foil 101. In the stacked body, Li foils 102, 102 are stacked on the surfaces of the Al layers 101b, 101b.

In the nonaqueous electrolyte liquid battery having formed a negative electrode by using the negative electrode precursor as described above, Li of the Li foil is reacted with Al of the Al layer at the coexistence of the nonaqueous electrolyte liquid, thereby forming a Li—Al alloy on the surface side in the Al layer (the separator side) where the Li foil is laminated, so as to be changed into an Al activation layer. In other words, at least on the surface side of the Al activation layer of the negative electrode (i.e., the Li foil side), there exists the Li—Al alloy which has been formed in the nonaqueous electrolyte liquid battery.

With respect to the stacked metal foil having joined an Al layer to the base material layer of the negative electrode precursor, the Al layer may be formed only on one surface of the base material layer, or Al layers may be formed on both surfaces of the base material layer as shown in FIG. 1.

It is noted that as shown in Table 1 when the Al layers are joined to both surfaces of the base material layer while the Li—Al alloy is formed on the surface sides of both Al layers, it is possible to more efficiently restrict transformation (e.g., curving) of the negative electrode and a change in volume and battery characteristic deterioration associated with such transformation, than a case where an Al layer is joined to one surface of the base material layer while a Li—Al alloy is formed on one surface side of the Al layer.

On the other hand, when the base material layer is made of a metal selected from Ni, Ti and Fe, and its alloy, it can be more possible to improve the action to restrict the negative electrode from transforming due to a change in volume when forming a Li—Al alloy. As a result, not only when the Al layers are joined to both surfaces of the base material layer but also when the Al layer is joined to only one surface of the base material layer to form the Li—Al alloy it is possible to more efficiently restrict transformation (e.g., curving) of the negative electrode and a change in volume and battery characteristic deterioration associated with such transformation.

When the stacked metal foil having joined the Al layer to the base material layer is joined to a Li foil to form a stacked body, the Li foil is laminated on the surface (i.e., the surface where the base material layer is not joined to) of the Al layer of both surfaces of the base material layer.

The following explanation is based on an embodiment in which the base material layer is Cu (Cu foil), or the base material layer is Ni (Ni foil), but the similar method can be applicable to another embodiment in which the base material layer is of a material other than Cu and Ni.

The examples of the stacked metal foil having joined a Cu layer to an Al layer can include a clad material of a Cu foil with an Al foil, and a stacked film having an Al layer formed on a Cu foil through vapor deposition of Al.

The examples of the Cu layer in the stacked metal foil having joined the Cu layer to the Al layer can include a layer made of Cu (which may include inevitable impurities), and a layer made of a Cu alloy containing an alloy ingredient such as Zr, Cr, Zn, Ni, Si and P, along with a reminder of Cu and inevitable impurities (the content of the alloy ingredient can be 10 mass % or less in total, or preferably 1 mass % or less).

The examples of the stacked metal foil having joined a Ni layer to an Al layer can include a clad material of a Ni foil with an Al foil, and a stacked film having an Al layer formed on a Ni foil through vapor deposition of Al.

The examples of the Ni layer in the stacked metal foil having joined the Ni layer to the Al layer can include a layer made of Ni (which may include inevitable impurities), and a layer made of a Ni alloy containing an alloy ingredient such as Zr, Cr, Zn, Cu, Fe, Si and P, along with a reminder of Ni and inevitable impurities (the content of the alloy ingredient can be 20 mass % or less in total).

Furthermore, the examples of the Al layer in the stacked metal foil having joined the Cu layer to the Al layer, or the examples of the Al layer in the stacked metal foil having joined the Ni layer to the Al layer can include a layer made of Al (which may include inevitable impurities), and an Al alloy containing an alloy ingredient such as Fe, Ni, Co, Mn, Cr, V T, Zr, Nb and Mo, along with a reminder of Al and inevitable impurities (the content of the alloy ingredient can be, for example, 50 mass % or lower in total).

Regarding the stacked metal foil having joined the Cu layer to the Al layer, or the stacked metal foil having joined the Ni layer to the Al layer, it can be contemplated to make the Li—Al alloy, that is to become the negative electrode active material, have a certain ratio. That is, assuming that the thickness of the base material layer, i.e., Cu layer or Ni layer, is 100, the thickness of the Al layer (The thickness is for one surface even when Al layers are joined to both surfaces of the base material layer, i.e., Cu layer or Ni layer. The same notion is applicable to the later explanation.) can be preferably 10 or more, and more preferably 20 or more, and yet more preferably 50 or more, and in particular preferably 70 or more. It can also be contemplated to improve the effect of current collection, and retain the Li—Al alloy sufficiently, with respect to the stacked metal foil having joined the Cu layer to the Al layer, or the stacked metal foil having joined the Ni layer to the Al layer. That is, assuming that the thickness of the base material layer, i.e., Cu layer or Ni layer, is 100, the thickness of the Al layer can be preferably 500 or less, and more preferably 400 or less, and yet more preferably 300 or less, and most preferably 200 or less.

In addition, the thickness of the base material layer, i.e., Cu layer or Ni layer can be preferably 10 to 50 μm, and more preferably 40 μm or less. Also, the thickness of the Al layer (The thickness is for one surface even when Al layers are joined to both surfaces of the base material layer, i.e.. Cu layer or Ni layer) can be favorably 10 μm or more, and more preferably 20 μm or more, and yet more preferably 30 μm or more. It can also be preferably 150 μm or less, and more preferably 70 μm or less, and yet more preferably 50 μm or less.

Regarding the stacked metal foil having joined the Cu layer to the Al layer, or the stacked metal foil having joined the Ni layer to the Al layer, it can be contemplated to make the capacity of the negative electrode have at least a certain amount. To do so, the thickness thereof can be favorably 50 μm or more, and more preferably 60 μm or more. It can be also contemplated to make a capacity ratio with the positive electrode active material in an appropriate range. To do so, the thickness thereof can be preferably 300 μm or less, and more preferably 200 μm or less, and yet more preferably 150 μm or less.

The examples of the Li foil to be used in the negative electrode precursor can include a foil of Li (which may include inevitable impurities), or a foil made of a Li alloy containing 40 mass % or less in total of Fe, Ni, Co, Mn, Cr, V, Ti, Zr, Nb and Mo, along with a reminder of Li and inevitable impurities as alloy ingredients.

There is a second method in addition to the first method described above, in which the Al activation layer of the negative electrode is formed by using the negative electrode precursor, that is, a stacked body having formed the Li foil on the surface of the stacked metal foil. In the second method, the stacked metal foil described above, the negative electrode precursor as it is can be used in assembling a battery After such assembling, the battery is charged to form an Al activation layer to constitute a negative electrode.

Namely, the Al located on at least the surface side of the Al metal layer of the stacked metal foil can be electrochemically reacted with the Li ions of the nonaqueous electrolyte liquid by the action of the charge of the battery, thereby obtaining an Al activation layer of a Li—Al alloy formed on at least the surface side thereof.

In the second method, because of using the stacked metal foil in which the Li foil is not laminated as the negative electrode precursor, it is possible to simplify the manufacturing process of the battery. However, when forming an Al activation layer from the negative electrode precursor, an irreversible capacity of the Li—Al alloy can offset with the Li of the Li layer of the negative electrode precursor. Therefore, in view of contemplating a high capacity, the first method can be preferably used to form a negative electrode (to form an Al activation layer of the negative electrode). In addition, it is possible that a battery is assembled by using the negative electrode precursor in accordance with the first method, and then, a negative electrode is formed by charging it (i.e., to form an Al activation layer of the negative electrode).

In the nonaqueous electrolyte liquid battery of the present invention, a metal base material layer which does not alloy with Li and an Al activation layer joined to the metal base material layer can be included in a stacked body to form a negative electrode of a battery. The crystal structure of the materials acting as the negative electrode active material can be kept well to stabilize the electric potential of the negative electrode, thereby securing a superior storage property. In either of the first method or the second method to form the Al activation layer of the negative electrode, when assuming that the total of the contents of the Li and the Al in the Al activation layer of the negative electrode is 100 atom %, it is preferable that the battery is used in such a way that the content of the Li is 48 atom % or less. Namely, at the time of charging a battery, it is preferable to finish the charge operation to the extent that the content of the Li of the Al activation layer does not exceed 48 atom % It is more preferable to finish the charge operation in the range where the content of the Li is 40 atom % or less. It is particularly preferable to finish the charge operation in the range where the content of the Li is 35 atom % or less.

It is possible that the whole of the Al layer of the stacked metal foil can alloy with Li to act as an active material. However, it is preferable that a base material layer side of the Al layer is not made into an alloy with Li, such that a stacked structure can be formed from an Al activation layer on the surface side and an Al layer left on the base material side.

Namely, it is considered that the following could happen when finishing the charge in a state as described above. The separator side (i.e., the positive electrode side) of the Al layer is reacted with Li to form a Li—Al alloy (a mixed phase of an a phase and a P phase, or a P phase). On the other hand, a part of the Al layer, that is close to the joint part with the base material layer, is supposed to substantially remain as an original Al layer without reacting with Li, or to have a content of Li lower than the separator side. Therefore, a superior adhesiveness between the original Al layer and the base material layer can be maintained, and therefore, it is considered to make it easy to hold the Li—Al alloy formed at the separator side on the base material layer. Particularly, it is more preferable to finish the charge at a condition where a phase is included in a mixed state in the Li—Al alloy formed at the separator side of the Al layer.

It is noted that in the specification of the present application, a phrase that “Al does not substantially alloy with Li” can include not only a state where the Al layer does not contain Li, but also a state of a phase where it contains Li of a solid solution at a content of several at % or lower. It is also noted that a phrase of “substantially without reacting with Li” can include a state where Li of a solid solution is contained at a content of several at % or lower, or a state where Al is maintained as a phase.

Also, the nonaqueous electrolyte liquid battery of the present invention can contemplate to increase the capacity and the heavy load discharge characteristics. In view of the above, assuming that the total of Li and Al is 100 atom %, the battery can be preferably charged until the content of Li reaches 15 atom % or more, and more preferably charged until the content of Li reaches 20 atom % or more.

Furthermore, the negative electrode of the nonaqueous electrolyte liquid battery of the present invention is desirable when it finishes the discharge at a state where an Al metal phase (a phase) coexists with a Li—Al alloy phase. As a result, a change in volume of the negative electrode at the time of charge and discharge can be controlled, thereby controlling capacity deterioration in a charge discharge cycle. In order to leave a 0 phase of the Li—Al alloy in the negative electrode, assuming that the total of Li and Al in the negative electrode is 100 atom %, the content of Li at the time when finishing the discharge can be maintained at approximately 3 atom % or more, and more preferably at 5 mass % or more. On the other hand, in order to increase a discharge capacity, it is preferable that the Li content at the time of finishing the discharge is 12 atom % or lower, and more preferably 10 atom % or lower.

In order to make it easy to follow the usage condition of the battery as described above, the nonaqueous electrolyte liquid battery of the present invention can contemplate a condition when a negative electrode precursor is used to form a negative electrode through the first method. That is, in assembling a battery, assuming that a thickness of the Al layer is 100, a thickness of the Li to be laminated with the Al layer is preferably managed to be 10, and more preferably 20 or more, and yet more preferably 30 or more. Also, it is preferably 80 or less, and it is more preferably 70 or less.

The thickness of the Li foil (a thickness of one surface if the stacked body has Li foils on both surfaces thereof), can be favorably 10 μm or more, and more preferably 20 μm or more, and yet more preferably 30 μm or more. Also, it can be preferably 80 μm or less, and yet more preferably at 70 μm or less.

An ordinary method such as a crimping process can be adopted in order to laminate a Li foil with an Al layer (an Al foil to constitute the Al layer, or an Al layer of foil constituted by joining an Al layer with a metal layer to constitute a negative electrode current collector).

The stacked body to use as a negative electrode precursor to use when preparing a negative electrode by the first method can be formed e.g., by laminating a Li foil on the surface of an Al layer of a foil formed by joining a Cu layer with an Al layer, or a foil formed by joining a Ni layer with an Al layer.

In accordance to an ordinary method, a negative electrode lead can be attached to the Cu layer or the Ni layer of the stacked body to be used as a negative electrode precursor in the first method or the second method, thereby forming a negative electrode.

For example, the positive electrode of the nonaqueous electrolyte battery of the present invention has a structure in which a positive electrode composition layer including a positive electrode active material, a conductive assistant and a binder is formed on one surface or both surfaces of the current collector. In addition, used in the positive electrode composition layer is lithium-containing nickel layered oxide containing 50 mol % or more of Ni with respect to Li.

Generally speaking, a positive electrode active material can react with a nonaqueous electrolyte liquid at a high temperature environment, thereby accumulating a reaction product on the positive electrode while gases are generated at the same time. When using a lithium cobalt oxide generally used in nonaqueous electrolyte liquid batteries such as a lithium ion secondary battery, the lithium cobalt oxide on its surface can react with the nonaqueous electrolyte liquid to accumulate a reaction product including Co at a high temperature while gases are generated at the same time. The reaction product including Co can further be decomposed to elute in the nonaqueous electrolyte liquid. Then, the lithium cobalt oxide on its surface can react with the nonaqueous electrolyte liquid to produce a reaction product including Co and gases. In other words, when a large amounts of lithium cobalt oxide is included in the positive electrode active material, whenever a battery is subject to a high temperature, Co can continuously elute and gases can be also continuously generated.

On the other hand, the lithium-containing nickel layered oxide including 50 mol % or more of Ni with respect to Li can react with a nonaqueous electrolyte liquid at a high temperature to produce a reaction product including Ni and gases, but the reaction product including Ni does not decompose and is left on the positive electrode to form a film. In addition, even when a battery is thereafter exposed to a high temperature, elution of Ni and generation of gases can be restricted. Therefore, when a lithium-containing nickel layered oxide including 50 mol % or more of Ni with respect to Li is used as a positive electrode active material, generation of gases can be restricted during storage for a long-term such as one month.

The lithium-containing nickel layered oxide including 50 mol % or more of Ni with respect to Li can be preferably a composite oxide represented by general composition formula (1) below. When using the composite oxide represented by general composition formula (1) below, it is possible to control not only gas generation but also resistance increase during long term storage.

Li₁₊ₓNi_{1-y-z}M¹_{y}M²_{z}O₂ (1)

In the general composition formula (1), M¹ represents at least one kind of elements selected from the group consisting of Co, Mn, Al Mg, Zr, Mo, Ti, Ba, W and Er, and M² represents an element other than Li, Ni and M¹, and −0.1≤x≤0.1, 0≤y≤0.5, 0≤z≤0.05.

When Co exists in the crystal lattice in the composite oxide represented by the general composition formula (1), it is possible to relieve an irreversible reaction caused by a phase transition of the lithium-containing composite oxide due to insertion and desorption of L during charge and discharge of the nonaqueous electrolyte liquid battery. As a result, a reversibility of the crystal structure of the composite oxide can be increased, thereby making it possible to constitute a nonaqueous electrolyte liquid battery having an extended life of a charge discharge cycle.

Also, when the composite oxide represented by general composition formula (1) includes Mg, the following can be expected. That is, when a phase transposition of the composite oxide is caused due to desorption and insertion of Li. Mg²⁺ can dislocate to the Li site, thereby relieving an irreversible reaction. As a result, it is possible to improve a reversibility of a layered crystal structure of the composite oxide that can be shown as a space group, R3-m.

When the composite oxide includes Mn at the same time, Mn, that is tetravalent, can stabilize Ni, that is unstable tetravalent, thereby making it possible to constitute a nonaqueous electrolyte liquid battery having an extended life of a charge discharge cycle.

When the composite oxide represented by the general composition formula (1) contains W or Mo, it can reduce a ratio of expansion or shrinkage of the crystal during charge and discharge, thereby contributing to an improvement of the charge discharge cycle characteristic of the battery.

When the composite oxide represented by the general composition formula (1) contains Al in the crystal lattice, its crystal structure can be stabilized, thereby improving thermal stability. As a result, it is possible to constitute a safer nonaqueous electrolyte liquid battery. In addition, since Al exists on grain boundaries and surfaces of the particles of the composite oxide, a temporal stability and a side reaction with the nonaqueous electrolyte can be controlled. As a result, it is possible to constitute a non-aqueous secondary battery with a longer life.

When Er exists on the grain boundaries and the surfaces of the particles of the composite oxide represented by the general composition formula (1), it can reduce a catalytic property at the surface of the positive electrode active material, thereby restricting the decomposition of the nonaqueous electrolyte liquid.

When the composite oxide represented by the general composition formula (1) contains the particles of an alkaline earth metal element such as Ba, the growth of the primary particle can be promoted, and the crystal characteristics of the composite oxide can be improved. As a result, a side reaction with a nonaqueous electrolyte liquid can be restricted, thereby making it possible to constitute a battery in which swollenness is hardly generated during high temperature storage.

When the composite oxide represented by the general composition formula (1) contains Ti in particles, it can be disposed in a crystalline defective part such as oxygen loss part in a LiNiO₂ type crystal structure, thereby stabilizing the crystal structure. As a result, the reversibility of the reaction of the composite oxide increases to constitute a non-aqueous secondary battery superior in the charge discharge cycle characteristics.

When the composite oxide represented by general composition formula (1) includes Zr, it can exist on grain boundaries and surfaces of the particles of the composite oxide. As a result, without deteriorating electrochemical properties of the composite oxide, the surface activity can be controlled. Also, Zr can provide an activity suppression effect on the particle surfaces. As a result, it is possible to constitute a non-aqueous secondary battery with a longer life.

In the composite oxide represented by the general composition formula (1), each element M¹ can be included if such properties demanded are demanded, or it can be excluded. In order to secure a battery capacity, the y number representing the content of element M¹ can be preferably less than 0.5, and more preferably 0.3 or less.

In the composite oxide represented by the general composition formula (1), the element M² other than Li, Ni and M¹ can be included, or excluded. The z number representing the content of element M² can be 0.05 or less to avoid the hindrance of the effects of the present invention, but it is more preferably 0.01 or less.

In addition, the lithium-containing nickel layered oxide represented by the general composition formula (1) includes 50 mol % or more of Ni with respect to Li. Therefore, the general composition formula (1) can satisfy y+z≤0.5.

The positive electrode active material can be composed only of a lithium-containing nickel layered oxide containing 50 mol % or more of Ni with respect to Li. Alternatively, it can additionally include another positive electrode active material other than the lithium-containing nickel layered oxide containing 50 mol % or more of Ni with respect to Li in accordance of demanded properties. As such a positive electrode active material that can be used along with the lithium-containing nickel layered oxide containing 50 mol % or more of Ni with respect to Li, ones conventionally used in nonaqueous electrolyte liquid batteries such as lithium ion secondary battery, (e.g., lithium-containing complex oxide capable of storing and releasing lithium ions, e.g., lithium cobalt oxide, and lithium iron phosphate in an olivine type) can be used. In this case, a ratio of the lithium-containing nickel layered oxide containing 50 mol % or more of Ni with respect to Li is preferably 50 mass % or more in the positive electrode active material included in the positive electrode, the effects as described above can be obtained. More preferably, it is 80 mass % or more.

The examples of the conductive assistant of the positive electrode composition layer can include carbon material such as: acetylene black, ketjen black, carbon black such as channel black, furnace black, lampblack, and thermal black, and carbon fibers. In addition, it can include conductive fibers such as metal fibers, fluorinated carbon, metal powders of copper, nickel, etc., and organic conductive material such as polyphenylene derivatives.

The examples of the binder used in the positive electrode composition layer can include polyvinylidene fluoride (PVDF), polytetrafluoroethylene (PTFE), styrene-butadiene rubber (SBR), carboxymetyl-cellulose (CMC), and polyvinylpyrrolidone (PVP).

For example, the positive electrode can be prepared as follows. A positive electrode composition including a positive electrode active material, a conductive assistant and a binder is dispersed into a solvent (an organic solvent such as NMP, or water) to prepare a positive electrode composition material (e.g., paste, slurry). This positive electrode composition material is applied to one surface or both surfaces of the current collector, which is followed by drying. Then, a press processing can be applied if necessary.

Alternatively, a molding body can be formed by using the positive electrode composition. Then, a positive electrode current collector can be laminated on a part or all of one surface of the molding body to obtain a positive electrode. When laminating the molded body of the positive electrode composition with the positive electrode current collector, a press processing or the like can be used.

As the current collector, the examples thereof can include a foil, a punched metal, a mesh or an expanded metal, which is made of Al or an Al alloy. Generally, an Al foil can be used. It is favorable that the thickness of the positive electrode current collector is, for example, 10 to 30 μm.

In the composition of the positive electrode composition layer, for example, it is preferable that a positive electrode active material is included at 80.0 to 99.8 mass %, a conductive assistant is included at 0.1 to 10 mass %, and a binder is included at 0.1 to 10 mass %. It is favorable that the thickness of the positive electrode composition layer is 50 to 300 μm per one side of the current collector.

The current collector of the positive electrode can be provided with a positive electrode lead in accordance with an ordinary method.

The capacity ratio of the positive electrode that is put together with the negative electrode can be designed such that the Li content becomes 15 to 48 atom %, assuming that the total of Li and Al at the negative electrode at the time of finishing the charge is 100 atom %. Furthermore, it is desirable to design the capacity ratio of the positive electrode such that a P phase of the Li—Al alloy is left in the negative electrode at the time of finishing the discharge.

In the nonaqueous electrolyte liquid battery of the present invention, an embodiment of the positive electrode and the negative electrode in use can be for example, an electrode body formed by stacking them with an intervention of a separator, a wound electrode body formed by further winding the electrode body, or a stacked electrode body formed by alternately stacking several positive electrodes and several negative electrodes.

The separator is preferably provided with a property to close its apertures (i.e., which is so called as a shutdown function) at a temperature of 80° C. or more (more favorably at a temperature of 100° C. or more) and 170° C. or less (more favorably at a temperature of 150° C. or less). The separator can be one used in nonaqueous electrolyte liquid batteries such as an ordinary lithium ion secondary battery. The examples thereof can include a fine porous membrane made of polyolefin such as polyethylene (PE) and polypropylene (PP). For example, the fine porous membrane constituting the separator can be made of PE or PP only. Alternatively, it can be a stacked body of a fine porous membrane of PE and a fine porous membrane of PP. For example, the thickness of the separator can be favorably 10 to 30 μm.

The nonaqueous electrolyte liquid battery of the present invention can be manufactured, for example, by inserting an electrode body into an exterior body, into which a nonaqueous electrolyte liquid is further injected to immerse the electrode body with the nonaqueous electrolyte liquid, and then the opening of the exterior body is sealed. The exterior body that can be used is one made of for example, steel, aluminum or an aluminum alloy, or one composed of a laminate film with metal deposited.

The nonaqueous electrolyte liquid that can be used is a solution dissolving a lithium salt into an organic solvent.

Examples of the organic solvent used in the nonaqueous liquid can include: cyclic carbonates such as ethylene carbonate, propylene carbonate (PC), butylene carbonate and vinylene carbonate; chain carbonates such as dimethyl carbonate, diethyl carbonate, and methyl ethyl carbonate; chain esters such as methyl propionate; cyclic esters such as a compound having a lactone ring; chain ethers such as dimethoxyethane, diethyl ether, 1,3-dioxolane, diglyme, triglyme, and tetraglyme; cyclic ethers such as dioxane, tetrahydrofuran, and 2-methyltetrahydrofuran; nitriles such as acetonitrile, propionitrile and methoxypropionitrile; and sulfurous esters such as ethylene glycol sulfite. The organic solvent that can be used here may be a mixture of two or more of these materials. In order to attain better battery characteristics, it is desirable to make a combination of the materials that can be able to achieve a high conductivity. The examples for this purpose can include a mixture solvent of a cyclic carbonate and the chain carbonate exemplified above.

Also, PC can be more preferably used as an organic solvent of a nonaqueous electrolyte liquid. PC can particularly contribute to securing of the electric discharge properties at a low temperature of the nonaqueous electrolyte liquid battery. For example, ethylene carbonate is often used as an organic solvent of a nonaqueous electrolyte liquid of nonaqueous electrolyte liquid batteries. PC has a freezing point lower than ethylene carbonate. Therefore, at a lower temperature environment, it can accomplish to raise the output properties of the battery.

Furthermore, in order to further improve the discharge properties at a low temperature of the nonaqueous electrolyte liquid battery, a compound having a lactone ring can be preferably used together with PC as an organic solvent of the nonaqueous electrolyte liquid.

The examples of the compound having a lactone ring can include lactones such as γ-butyrolactone and one with a substituent at the a position.

Also, it is preferable to use, for example, a 5-membered ring compound (which has a ring made of four carbon atoms) as lactones having a substituent at the a position. The number of the substituent at a position of the lactones can be one or two.

The examples of the substituent can include a hydrocarbon group and a halogen group (fluoro group, chloro group, bromo group, iodo group). The examples of the hydrocarbon group can preferably include an alkyl group and an aryl group, in which the number of carbon atom can be preferably 1 or more and 15 or less (preferably 6 or less). When the substituent is the hydrocarbon group, it can be more preferably the methyl group, ethyl group, propyl group, butyl group, or the phenyl group.

The specific examples of the lactone having a substituent at a position can include: α-methyl-γ-butyrolactone, α-ethyl-γ-butyrolactone, α-propyl-γ-butyrolactone, α-butyl-γ-butyrolactone, α-phenyl-γ-butyrolactone, α-fluoro-γ-butyrolactone, α-chloro-γ-butyrolactone, α-bromo-γ-butyrolactone, α-iodo-γ-butyrolactone, α,α-dimethyl-γ-butyrolactone, α,α-diethyl-γ-butyrolactone, α,α-diphenyl-γ-butyrolactone, α-ethyl-α-methyl-γ-butyrolactone, α-methyl-α-phenyl-γ-butyrolactone, α,α-difluoro-γ-butyrolactone, α,α-dichloro-γ-butyrolactone, α,α-dibromo-γ-butyrolactone, and α,α-diiodo-γ-butyrolactone. One kind of these can be used alone, or two or more kinds thereof can be used in combination. Among these, α-methyl-γ-butyrolactone is more preferable.

The PC content in the whole organic solvent used in the nonaqueous electrolyte liquid can be determined in view of favorably securing the effect by using it. Therefore, it can be preferably 10 volume % or more, and more preferably, 30 volume % or more. It is noted that the organic solvent of the nonaqueous electrolyte liquid can be PC only, as explained before. Therefore, the upper limit of the suitable PC content can be 100 volume % in the whole organic solvent used in the nonaqueous electrolyte liquid.

In addition, when the compound having a lactone ring is used, it can be contemplated to favorably secure the effect from such use. Therefore, the content of the compound having a lactone ring in the whole organic solvent used in a nonaqueous electrolyte liquid can be preferably 0.1 mass % or more. It is preferable to use it by satisfying the suitable value thereof while the PC content of the whole organic solvent also satisfies the suitable value explained before.

The lithium salt used in the nonaqueous electrolyte liquid can have a high heat resistance and improve storage properties of the nonaqueous electrolyte liquid battery at a high temperature environment. In addition, it can be provided with a function to restrict aluminum used in a battery from corroding. Therefore, LiBF₄ can be preferably used.

The examples of the other lithium salts contained in the nonaqueous electrolyte liquid can include LiClO₄, LiPF₆, LiAsF₆. LiSbF₆. LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (n≥2) and LiN(RfOSO₂)₂ (wherein Rf represents a fluoroalkyl group).

The concentration of the lithium salt in the non-aqueous electrolytic solution is preferably 0.6 mol/L, and more preferably 0.9 mol/L or more.

The concentration of the whole lithium salt in the non-aqueous electrolytic solution is preferably 1.8 mol/L or less, and more preferably 1.6 mol/L or less. Thus, when only LiBF₄ is used as a lithium salt, it is preferably used at a concentration satisfying the favorable upper limit as explained above. On the other hand, when another lithium salt is used together with LiBF₄, it is preferable that the lower limit of the concentration of LiBF₄ is met while the favorable upper limit of the whole lithium salt is met.

Also, the nonaqueous electrolyte liquid can preferably include a nitrile compound as an additive. By using a nonaqueous electrolyte liquid with a nitrile compound added, the nitrile compound adheres to the surface of the positive electrode active material to form a film, and the film restricts gasification due to oxidative decomposition of the nonaqueous electrolyte liquid. As a result, it is possible to prevent the battery from swelling particularly when stored at a high temperature environment.

The examples of the nitrile type additive can include mononitriles such as acetonitrile, propionitrile, butyronitrile, valeronitrile, benzonitrile and acrylonitrile; dinitriles such as malononitrile, succinonitrile, glutaronitrile, adiponitrile, 1,4-dicyanoheptane, 1,5-dicyanopentane (pimelonitrile), 1,6-dicyanohexane (suberonitrile), 1,7-dicyanoheptane (azelaonitrile), 2,6-dicyanoheptane, 1,8-dicyanooctane, 2,7-dicyanooctane, 1,9-dicyanononane, 2,8-dicyanononane, 1,10-dicyanodecane, 1,6-dicyanodecane, and 2,4-methylglutaronitrile, cyclic nitriles such as benzonitrile; and alkoxy substituted nitriles such as methoxyacetonitrile. One kind of these can be used alone, or two or more kinds thereof can be used in combination. Among these nitrile compounds, dinitriles are preferable, and adiponitrile, pimelonitrile and suberonitrile are more preferable.

The content of the nitrile compound in the nonaqueous electrolyte liquid used in the battery can be determined in view of favorably securing the effect from such use. Therefore, it can be preferably 0.1 mass % or more, and more preferably, 1 mass % or more. However, when too much quantities of the nitrile compound are included in nonaqueous electrolyte liquid, there can be a tendency to decrease the discharge properties at a low temperature of the battery. Therefore, in order to restrict the quantity of the nitrile compound in nonaqueous electrolyte liquid to some extent so as to make better discharge properties at a low temperature of the battery, the content of the nitrile compound in nonaqueous electrolyte liquid used in a battery is preferably 10 mass % or lower, and more preferably 5 mass % or lower.

In addition, the nonaqueous electrolyte liquid preferably includes a phosphoric acid compound including a group represented by general formula (2) in its molecule.

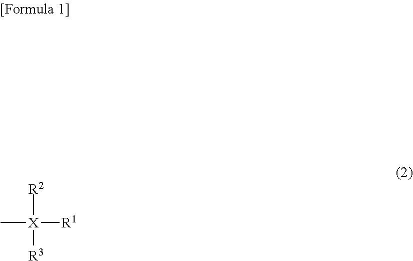

In general formula (2), X represents Si, Ge or Sn; R¹, R² and R³ each independently represent an alkyl group having a carbon number of 1 to 10, an alkenyl group having a carbon number of 2 to 10, and an aryl group having a carbon number of 6 to 10, in which a part or all of hydrogen atoms thereof are optionally substituted with fluorine.

For example, the battery used in vehicle equipment is supposed to be used not only at a high temperature environmental but also at a cold district. At a low temperature environment, a battery operability tends to decrease compared with used at normal temperature. Especially, an aging battery tends to lower its load characteristics. Therefore, assuming it is used at every temperature, it is preferable that it can discharge at a low temperature environment with a high load, even after stored at a high temperature environment for a certain period (thereby simulating an aging condition).

In the nonaqueous electrolyte liquid battery of the present invention, when a nonaqueous electrolyte liquid includes a phosphoric acid compound having a group represented by general formula (2) in its molecule, it is possible to raise high-load discharge characteristics at a low temperature environment after a long-term storage at a high temperature. The reason has not been proven, but the inventors consider as follows.

When a nonaqueous electrolyte liquid includes the phosphoric acid compound having a group represented by general formula (2) in its molecule, the phosphoric acid compound forms a low resistance and strong film on the surfaces of the lithium-containing nickel layered oxide containing 50 mol % or more of Ni as with respect to Li. The film is not broken even after subjecting the battery to a long-term storage at a high temperature. Also, this film is hard to prevent Li ions from insertion even at a low temperature. As a result, it can make better heavy load discharge characteristics at a low temperature of a battery even after a long-term storage at a high temperature.

Furthermore, at the negative electrode of the nonaqueous electrolyte liquid battery, the phosphoric acid compound acts to form a film. It is considered that the phosphoric acid compound can decrease the Li quantity used when a film is formed on the negative electrode surface, thereby forming a thin high-quality film on the negative electrode surface. As a result, the film on the negative electrode surface is not broken even during a long-term storage at a high temperature, thereby restricting deterioration of the negative electrode. Also, this film is hard to prevent Li ions from desorption even at a low temperature. By these reasons, it can make better heavy load discharge characteristics at a low temperature of the battery even after a long-term storage at a high temperature, as well.

As explained above, by combining a specific positive electrode and a specific negative electrode of the present invention together with a nonaqueous electrolyte liquid including the phosphoric acid compound, each action as explained above can function synergistically, and as a result, it is possible to provide a battery that is good at storage properties at a high temperature environment and that can be also subject to a temperature change.

In the general formula (2), X can be Si, Ge or Sn, but Si is more preferable (namely, the phosphoric acid compound is preferably a phosphoric acid silyl ester). In the general formula (2), R¹, R² and R³ each independently represent an alkyl group having a carbon number of 1 to 10, an alkenyl group having a carbon number of 2 to 10, and an aryl group having a carbon number of 6 to 10. However, a methyl group or an ethyl group is more preferable. In addition, the group represented by the general formula (2) is particularly preferably a trimethylsilyl group.

Regarding the phosphoric acid compound, only one of the hydrogen atoms of the phosphoric acid can be substituted with the group represented by the general formula (2), or two of the hydrogen atoms of the phosphoric acid can be substituted with the group represented by the general formula (2), or all three of the hydrogen atoms of the phosphoric acid can be substituted with the group represented by the general formula (2). It is, however, more preferable if all three of the hydrogen atoms of the phosphoric acid are substituted with the group represented by the general formula (2).

The phosphoric acid compound can be particularly preferable if it is a (tris)trimethylsilyl phosphate.

In the nonaqueous electrolyte liquid used in the battery, the content of the phosphoric acid compound having the group represented by the general formula (2) in its molecule can be determined in view of favorably securing the effect from such use. Therefore, it can be preferably 0.2 mass % or more, and more preferably 0.5 mass % or more. On the other hand, when the content is too much, gas generation at the time of forming the film can be increased. Therefore, in the nonaqueous electrolyte liquid used in the battery, the content of the phosphoric acid compound having the group represented by the general formula (2) in its molecule can preferably be 7 mass % or less, and more preferably be 5 mass % or less, and yet more preferably be 3 mass % or less.

In the nonaqueous electrolyte liquid battery it is particularly preferable if using a nonaqueous electrolyte liquid which includes the phosphoric acid compound along with LiBF₄ as a lithium salt, which further includes PC as an organic solvent, which furthermore includes a nitrile compound. When using such a nonaqueous electrolyte liquid, the action from each component can function synergistically. As a result, the swollenness of the battery at high temperature storage can be highly controlled, while it is possible to improve the discharge properties at a low temperature environment (for example, at a temperature of −20° C. or less) even after high temperature storage.

In addition, for the purpose of further improving various battery characteristics, the nonaqueous electrolyte liquid can appropriately include an additive such as vinylene carbonate, 1,3-propanesultone, diphenyl disulfide, cyclohexylbenzene, biphenyl, fluorobenzene and t-butylbenzene. Furthermore, the nonaqueous electrolyte liquid can be provided as a gelled state (gelled electrolyte) by using a gelatification agent such as a known polymer.

In addition, the nonaqueous electrolyte liquid battery of the present invention is comprised under a positive electrode capacity regulation. By controlling the charging quantity of electricity or controlling the charge voltage, the time having finished the charging can be detected. Therefore, it is possible to preset a charge end condition at the charging circuit.

It is preferable that the battery assembled is fully charged followed by subjecting it to an aging processing at a high temperature (e.g., 60° C.). The formation of a Li—Al alloy can be advanced at the negative electrode at the aging processing, thereby further improving the capacity and the load characteristic of the battery.

### EXAMPLES

Hereinafter, the present invention is described in more detail based on the examples. It is, however, noted that the following examples should not be used to narrowly construe the scope of the present invention.

### Example 1

A clad material (stacked metal foil) used as a negative electrode precursor had a size of 25 mm×40 mm formed by respectively laminating an Al foil having a thickness of 30 μm on both surfaces of a Ni foil having a thickness of 30 μm. To the end of the clad material, a Cu foil of current collection was attached through an ultrasonic welding process. Furthermore, a Ni tab for the purpose of conductive connection to the battery outside was welded through an ultrasonic welding process to the end of the Cu foil, which was used for assembling the battery.

On the other hand, the positive electrode was prepared as follows, 97 parts by mass of LiNi_{0.80}Co_{0.15}Al_{0.05}O₂, 1.5 parts by mass of acetylene black as a conductive assistant, and 1.5 parts by mass of PVDF as a binder was dispersed in NMP to form a slurry, which was then applied on one surface of the Al foil to become a thickness of 12 μm, followed by drying it and subject it to a press process, thereby forming a positive electrode composition layer on one surface of the Al foil current collector at a mass of approximately 17 mg/cm². It is noted that the positive electrode composition layer was not formed at a part of the coated surface of the slurry to partially expose the Al foil. Then, the Al foil current collector was cut into a size of 20 mm×45 mm. To the exposed part of the Al foil, an Al tab for conductive connection to the battery outside was attached through an ultrasonic welding process, thereby preparing a positive electrode having a positive electrode composition layer with a size of 20 mm×30 mm at one surface of the current collector.

On both sides of the negative electrode precursor having welded the Ni tab, the positive electrode was stacked with intervention of a separator that is a PE microporous film having a thickness of 16 μm each, thereby obtaining a set of an electrode body. Also, to a mixture solvent of propylene carbonate (PC) and ethyl methyl carbonate (EMC) at a volume ratio of 1:2. LiBF₄ was dissolved at a concentration of 1 mol/L, followed by further adding adiponitrile at a quantity to become 3 mass %, thereby obtaining a nonaqueous electrolyte liquid. The electrode body was dried at 60 degrees Celsius in vacuum for 15 hours, which was inserted into a laminate film exterior body along with the nonaqueous electrolyte liquid. As a result, a nonaqueous electrolyte liquid battery with a rating capacity of 30 mAh was obtained, having an appearance of FIG. 2 and a cross sectional view of FIG. 3.

Here, FIG. 2 and FIG. 3 are explained. FIG. 2 is a plan view schematically showing a nonaqueous electrolyte liquid battery, and FIG. 3 is a cross sectional view at line I-I of FIG. 2. The nonaqueous electrolyte liquid battery 1 has a structure below. Inside the laminate film exterior body 2 composed of two sheets of laminate films, there are provided the stacked electrode body provided by stacking the positive electrode 5 and the negative electrode 6 with intervention of a separator 7, and the nonaqueous electrolyte liquid (not shown). The laminate film exterior body 2 has a structure in which the outer periphery thereof is sealed through heat fusion of the laminate films at the top and bottom. It is noted that the illustration of the drawing in FIG. 3 is simplified such that it does not distinguishably show each layer constituting the laminate film exterior body 2, as well as the positive electrode 5 and the negative electrode 6.

The positive electrode 5 connects to the positive electrode external terminal 3 through a lead body in battery 1. In addition, while not illustrated, the negative electrode 6 connects to the negative electrode external terminal 4 through a lead body in battery 1. Then, the positive electrode external terminal 3 and the negative electrode external terminal 4 are drawn outside the laminate film exterior body 2 in order to allow them to connect to external devices.

### Example 2

The positive electrode active material was replaced with LiNi_{0.85}Co_{0.10}Mn_{0.025}Al_{0.01}Mg_{0.01}Ba_{0.005}O₂. Other than this replacement, the same procedure as performed in Example 1 was repeated to obtain a positive electrode. Except for using this positive electrode, the same procedure as Example 1 was performed to prepare a nonaqueous electrolyte liquid battery.

### Example 3

The positive electrode active material was replaced with LiNi_{0.80}Co_{0.10}Mn_{0.10}O₂. Other than this replacement, the same procedure as performed in Example 1 was repeated to obtain a positive electrode. Except for using this positive electrode, the same procedure as Example 1 was performed to prepare a nonaqueous electrolyte liquid battery.

### Example 4

A clad material (stacked metal foil) used as a negative electrode precursor had a size of 25 mm×40 mm formed by respectively stacking an Al foil having a thickness of 30 μm on both surfaces of a Cu foil having a thickness of 30 μm. Except for using this negative electrode, the same procedure as Example 1 was performed to prepare a nonaqueous electrolyte liquid battery.

### Example 5

A clad material (stacked metal foil) used as a negative electrode precursor had a size of 25 mm×40 mm formed by stacking an Al foil having a thickness of 30 μm on one surface of a Ni foil having a thickness of 30 μm. Except for using this negative electrode, the same procedure as Example 1 was performed to prepare a nonaqueous electrolyte liquid battery.

### Example 6

Except for changing the adiponitrile content into 0.9 mass %, the same procedure as Example 1 was performed to prepare a nonaqueous electrolyte liquid. Then, except for using this nonaqueous electrolyte liquid, the same procedure as Example 1 was performed to prepare a nonaqueous electrolyte liquid battery.

### Example 7

Except for replacing the adiponitrile with suberonitrile, the same procedure as Example 1 was performed to prepare a nonaqueous electrolyte liquid. Then, except for using this nonaqueous electrolyte liquid, the same procedure as Example 1 was performed to prepare a nonaqueous electrolyte liquid battery.

### Example 8

Except for replacing the LiBF₄ with LiPF₆, the same procedure as Example 1 was performed to prepare a nonaqueous electrolyte liquid. Then, except for using this nonaqueous electrolyte liquid, the same procedure as Example 1 was performed to prepare a nonaqueous electrolyte liquid battery.

### Example 9

Into a mixture solvent of ethylene carbonate (EC) and ethyl methyl carbonate (EMC) at a volume ratio of 1:2, LiBF₄ was dissolved at a concentration of 1 mol/L, followed by further adding adiponitrile at a quantity to become 3 mass %, thereby obtaining a nonaqueous electrolyte liquid. Then, except for using this nonaqueous electrolyte liquid, the same procedure as Example 1 was carried out to prepare a nonaqueous electrolyte liquid battery.

### Comparative Example 1

The positive electrode active material was replaced with LiCoO₂. Other than this replacement, the same procedure as performed in Example 1 was repeated to obtain a positive electrode. Except for using this positive electrode, the same procedure as Example 1 was performed to prepare a nonaqueous electrolyte liquid battery.

### Comparative Example 2

The positive electrode active material was replaced with LiNi_{0.33}Co_{0.33}Mn_{0.33}O₂. Other than this replacement, the same procedure as performed in Example 1 was repeated to obtain a positive electrode. Other than the use of the positive electrode, the same procedure as Example 1 was performed to prepare a nonaqueous electrolyte liquid battery.

With respect to the nonaqueous electrolyte liquid batteries of Examples 1 to 9 and Comparative Examples 1 and 2, the storage property 1 and the storage properties 2 explained below were evaluated.

### <Storage Characteristic 1>

Each battery of the Examples and the Comparison Examples were applied to a constant current (6 mA) and constant voltage (4.0V) charging. At the time when a charging electric current decreased to 0.3 mA, the charging was stopped. Furthermore, it was charged at the same charging condition to make the battery a full charged state. Each battery at the full charged state was hung with a thin silk thread, and submerged such that the battery was completely under pure water, and its weight under water was measured. Each battery at the full charged state was stored at 85° C. for 10 days, and then, it cooled off to room temperature. Then, its weight under water was measured in the same way as explained above. A volume difference before and after the storage was calculated from the difference from the weight before the storage. The volume difference was assumed to be an amount 1 of change in volume in the battery.

### <Storage Characteristic 2>

Each battery of the Example and the Comparative Examples (these batteries were different from those stored for 10 days.) were made into the full charged state by the same way as explained before. Each battery at the full charged state was hung with a thin silk thread, and submerged such that the battery was completely under pure water, and its weight under water was measured. Each battery at the full charged state was stored at 85° C. for 30 days, and then, it cooled off to room temperature. Then, its weight under water was measured in the same way as explained above. A volume difference before and after the storage was calculated from the difference from the weight before the storage. The volume difference was assumed to be an amount 2 of change in volume in the battery.

The constructions of the nonaqueous electrolyte liquid batteries of Examples 1 to 9 and Comparative Examples 1 and 2 are shown in Table 1 and Table 2. The evaluation results of the storage property 1 and the storage property 2 are shown in Table 3.

TABLE 1

| | | Negative Electrode | |
|---|---|---|---|
| | | Base | Provision of |
| | | Material | AI Active |
| | Positive Active Material | Layer | Layer |
| Example 1 | LiNi_{0.80}Co_{0.15}Al_{0.05}O₂ | Ni | Both |
| | | | Surfaces |
| Example 2 | LiNi_{0.85}Co_{0.10}Mn_{0.025}Al_{0.01}Mg_{0.01}Ba_{0.005}O₂ | Ni | Both |
| | | | Surfaces |
| Example 3 | LiNi_{0.80}Co_{0.10}Mn_{0.10}0₂ | Ni | Both |
| | | | Surfaces |
| Example 4 | LiNi_{0.80}Co_{0.15}Al_{0.05}0₂ | Cu | Both |
| | | | Surfaces |
| Example 5 | LiNi_{0.80}Co_{0.15}Al_{0.05}0₂ | Ni | One Surface |
| Example 6 | LiNi_{0.80}Co_{0.15}Al_{0.05}0₂ | Ni | Both |
| | | | Surfaces |
| Example 7 | LiNi_{0.80}Co_{0.15}Al_{0.05}0₂ | Ni | Both |
| | | | Surfaces |
| Example 8 | LiNi_{0.80}Co_{0.15}Al_{0.05}0₂ | Ni | Both |
| | | | Surfaces |
| Example 9 | LiNi_{0.80}Co_{0.15}Al_{0.05}0₂ | Ni | Both |
| | | | Surfaces |
| Comparative | LiCoO₂ | Ni | Both |
| Example 1 | | | Surfaces |
| Comparative | LiNi_{0.33}Co_{0.33}Mn_{0.33}O₂ | Ni | Both |
| Example 2 | | | Surfaces |

TABLE 2

| | Nonaqueous Electrolyte Liquid | | | |
|---|---|---|---|---|
| | | | Content of | Content of |
| | Organic | | Adiponitrile | Suberonitrile |
| | Solvent | Lithium Salt | (Mass %) | (Mass %) |
| Example 1 | PC/EMC | LiBF₄ | 3 | 0 |
| Example 2 | PC/EMC | LiBF₄ | 3 | 0 |
| Example 3 | PC/EMC | LiBF₄ | 3 | 0 |
| Example 4 | PC/EMC | LiBF₄ | 3 | 0 |
| Example 5 | PC/EMC | LiBF₄ | 3 | 0 |
| Example 6 | PC/EMC | LiBF₄ | 0.9 | 0 |
| Example 7 | PC/EMC | LiBF₄ | 0 | 3 |
| Example 8 | PC/EMC | LiPF₆ | 3 | 0 |
| Example 9 | EC/EMC | LiBF₄ | 3 | 0 |
| Comparative | PC/EMC | LiBF₄ | 3 | 0 |
| Example 1 | | | | |
| Comparative | PC/EMC | LiBF₄ | 3 | 0 |
| Example 2 | | | | |

TABLE 3

| | (Storage Characteristic 1) | (Storage Characteristic 2) |
|---|---|---|
| | Amount of Change in | Amount of Change in |
| | Volume After 10 Days of | Volume After 30 Days of |
| | High Temperature Storage | High Temperature Storage |
| | (cm³) | (cm³) |
| Example 1 | 0.29 | 0.30 |
| Example 2 | 0.41 | 0.44 |
| Example 3 | 0.39 | 0.40 |
| Example 4 | 0.31 | 0.33 |
| Example 5 | 0.34 | 0.35 |
| Example 6 | 0.70 | 0.75 |
| Example 7 | 0.40 | 0.43 |
| Example 8 | 0.58 | 0.95 |
| Example 9 | 0.39 | 0.82 |
| Comparative | 0.25 | 1.46 |
| Example 1 | | |
| Comparative | 0.19 | 1.08 |
| Example 2 | | |

### [Examples of the Nonaqueous Electrolyte Liquid Batteries Using a Nonaqueous Electrolyte Liquid Including a Phosphoric Acid Compound Having a Group Represented by General Formula (2) in its Molecule]

### Example 10

Except for adding tris(trimethylsilyl) phosphate at a quantity to become 3 mass %, the same procedure as Example 1 was performed to prepare a nonaqueous electrolyte liquid. Then, except for using this nonaqueous electrolyte liquid, the same procedure as Example 1 was performed to prepare a nonaqueous electrolyte liquid battery.

### Example 11

Except for using the nonaqueous electrolyte liquid prepared in Example 10, the same procedure as Example 2 was performed to prepare a nonaqueous electrolyte liquid battery.

### Example 12

Except for using the nonaqueous electrolyte liquid prepared in Example 10, the same procedure as Example 3 was performed to prepare a nonaqueous electrolyte liquid battery.

### Example 13

Except for using the nonaqueous electrolyte liquid prepared in Example 10, the same procedure as Example 4 was performed to prepare a nonaqueous electrolyte liquid battery.

### Example 14

Except for replacing the adiponitrile with suberonitrile, the same procedure as Example 10 was performed to prepare a nonaqueous electrolyte liquid. Then, except for using this nonaqueous electrolyte liquid, the same procedure as Example 1 was performed to prepare a nonaqueous electrolyte liquid battery.

### Example 15

Except for replacing the LiBF₄ with LiPF₆, the same procedure as Example 10 was performed to prepare a nonaqueous electrolyte liquid. Then, except for using this nonaqueous electrolyte liquid, the same procedure as Example 1 was performed to prepare a nonaqueous electrolyte liquid battery.

### Example 16

Into a mixture solvent of ethylene carbonate (EC) and ethyl methyl carbonate (EMC) at a volume ratio of 1:2, LiBF₄ was dissolved at a concentration of 1 mol/L, followed by further adding adiponitrile at a quantity to become 3 mass % and tris(trimethylsilyl) phosphate at a quantity to become 3 mass %, thereby obtaining a nonaqueous electrolyte liquid. Then, except for using this nonaqueous electrolyte liquid, the same procedure as Example 1 was carried out to prepare a nonaqueous electrolyte liquid battery.

### Example 17

Except for changing the tris(trimethylsilyl) phosphate content into 0.5 mass %, the same procedure as Example 10 was performed to prepare a nonaqueous electrolyte liquid. Then, except for using this nonaqueous electrolyte liquid, the same procedure as Example 1 was performed to prepare a nonaqueous electrolyte liquid battery.

### Example 18

Except for changing the tris(trimethylsilyl) phosphate content into 5 mass %, the same procedure as Example 10 was performed to prepare a nonaqueous electrolyte liquid. Then, except for using this nonaqueous electrolyte liquid, the same procedure as Example 1 was performed to prepare a nonaqueous electrolyte liquid battery.

### Comparative Example 3

Except for using the nonaqueous electrolyte liquid prepared in Example 10, the same procedure as Comparative Example 1 was performed to prepare a nonaqueous electrolyte liquid battery.

### Comparative Example 4

Except for using the nonaqueous electrolyte liquid prepared in Example 10, the same procedure as Comparative Example 2 was performed to prepare a nonaqueous electrolyte liquid battery.

With respect to the nonaqueous electrolyte liquid batteries of Examples 10 to 18 and Comparative Examples 3 and 4, the storage property 1 and the storage properties 2 explained were evaluated in the same manner as the battery of Example 1, etc. In addition, they were evaluated by measuring a discharge time at a low temperature after high temperature storage by the method as explained below. It is noted that the measurement of the discharge time at a low temperature after high temperature storage was carried out also on the battery of the Example 1 [i.e., the battery which had a nonaqueous electrolyte liquid that did not include a phosphoric acid compound having a group represented by the general formula (2)].

<Discharge time at a low temperature after a high temperature storage> Each battery of the Example and the Comparative Examples (these batteries were different from those stored for 10 days or for 30 days.) were made into the full charged state by the same way as explained before. Each battery at a full charged state was stored at 85° C. for 10 days. Then, it was discharged at an environment of −20° C. to reach 2.0V at a constant current of 45 mA. The length of this discharging duration was measured.

The constructions of the nonaqueous electrolyte liquid batteries of Examples 1 and 10 to 18, and Comparative Examples 3 and 4 are shown in Table 4 and Table 5. The evaluation results are shown in Table 6.

TABLE 4

| | | Negative Electrode | |
|---|---|---|---|
| | | Base | Provision of |
| | | Material | AI Active |
| | Positive Active Material | Layer | Layer |
| Example 10 | LiNi_{0.80}Co_{0.15}Al_{0.05}O₂ | Ni | Both |
| | | | Surfaces |
| Example 11 | LiNi_{0.85}Co_{0.10}Mn_{0.025}Al_{0.01}Mg_{0.01}Ba_{0.005}O₂ | Ni | Both |
| | | | Surfaces |
| Example 12 | LiNi_{0.80}Co_{0.10}Mn_{0.10}O₂ | Ni | Both |
| | | | Surfaces |
| Example 13 | LiNi_{0.80}Co_{0.15}Al_{0.05}O₂ | Cu | Both |
| | | | Surfaces |
| Example 14 | LiNi_{0.80}Co_{0.15}Al_{0.05}O₂ | Ni | Both |
| | | | Surfaces |
| Example 15 | LiNi_{0.80}Co_{0.15}Al_{0.05}O₂ | Ni | Both |
| | | | Surfaces |
| Example 16 | LiNi_{0.80}Co_{0.15}Al_{0.05}O₂ | Ni | Both |
| | | | Surfaces |
| Example 17 | LiNi_{0.80}Co_{0.15}Al_{0.05}O₂ | Ni | Both |
| | | | Surfaces |
| Example 18 | LiNi_{0.80}Co_{0.15}Al_{0.05}O₂ | Ni | Both |
| | | | Surfaces |
| Comparative | LiCoO₂ | Ni | Both |
| Example 3 | | | Surfaces |
| Comparative | LiNi_{0.33}Co_{0.33}Mn_{0.33}O₂ | Ni | Both |
| Example 4 | | | Surfaces |
| Example 1 | LiNi_{0.80}Co_{0.15}Al_{0.05}O₂ | Ni | Both |
| | | | Surfaces |

TABLE 5

| | Nonaqueous Electrolyte Liquid | | | | |
|---|---|---|---|---|---|
| | | | | | Content of |
| | | | Content of | Content of | Tris(Tris- |
| | | | Adipo- | Subero- | methyl) |
| | Organic | Lithium | nitrile | nitrile | Phosphate |
| | Solvent | Salt | (Mass %) | (Mass %) | (Mass %) |
| Example 10 | PC/EMC | LiBF₄ | 3 | 0 | 3 |
| Example 11 | PC/EMC | LiBF₄ | 3 | 0 | 3 |
| Example 12 | PC/EMC | LiBF₄ | 3 | 0 | 3 |
| Example 13 | PC/EMC | LiBF₄ | 3 | 0 | 3 |
| Example 14 | PC/EMC | LiBF₄ | 0 | 3 | 3 |
| Example 15 | PC/EMC | LiPF₆ | 3 | 0 | 3 |
| Example 16 | EC/EMC | LiBF₄ | 3 | 0 | 3 |
| Example 17 | PC/EMC | LiBF₄ | 3 | 0 | 0.5 |
| Example 18 | PC/EMC | LiBF₄ | 3 | 0 | 5 |
| Comparative | PC/EMC | LiBF₄ | 3 | 0 | 3 |
| Example 3 | | | | | |
| Comparative | PC/EMC | LiBF₄ | 3 | 0 | 3 |
| Example 4 | | | | | |
| Example 1 | PC/EMC | LiBF₄ | 3 | 0 | 0 |

TABLE 6

| | (Storage Characteristic 1) | (Storage Characteristic 2) | Discharge Time at a |
|---|---|---|---|
| | Amount of Change in | Amount of Change in | Low Temperature |
| | Volume After 10 Days of | Volume After 30 Days of | After a High |
| | High Temperature Storage | High Temperature Storage | Temperature Storage |
| | (cm³) | (cm³) | (minutes) |
| Example 10 | 0.33 | 0.34 | 23 |
| Example 11 | 0.45 | 0.48 | 18 |
| Example 12 | 0.43 | 0.44 | 16 |
| Example 13 | 0.34 | 0.36 | 24 |
| Example 14 | 0.44 | 0.47 | 20 |
| Example 15 | 0.64 | 0.98 | 12 |
| Example 16 | 0.43 | 0.89 | 14 |
| Example 17 | 0.30 | 0.31 | 11 |
| Example 18 | 0.85 | 0.96 | 25 |
| Comparative | 0.25 | 1.46 | 22 |
| Example 3 | | | |
| Comparative | 0.19 | 1.08 | 18 |
| Example 4 | | | |
| Example 1 | 0.29 | 0.30 | 5 |

There are other embodiments than the description above without departing the gist of the present invention. The embodiment described above is an example, and the present invention is not limited to the embodiment. The scope of the present invention should be construed primarily based on the claims, not to the description of the specification or the present application. Any changes within the ranges of the claims and the equivalence thereof should be construed as falling within the scope of the claims.

### INDUSTRIAL UTILITY

The nonaqueous electrolyte liquid battery of the present invention has good storage properties at a high temperature environment. Due to these characteristics, it can be preferably applied to the use such as power supply of the vehicle equipment, i.e., the use in which well maintenance of a capacity at a high temperature environment for a long term is demanded.

### EXPLANATION OF THE REFERENCES IN THE DRAWINGS

1: Nonaqueous electrolyte liquid battery
2: Laminate film exterior body
5: Positive electrode
6: Negative electrode
7: Separator
100: Negative electrode precursor
101: stacked metal foil
101a: metal base material layer
101b: Al metal layer
102: Li foil

1. A nonaqueous electrolyte liquid battery comprising an electrode body in which a positive electrode and a negative electrode are stacked with an intervention of a separator, and a nonaqueous electrolyte liquid comprising a lithium salt and an organic solvent, wherein the positive electrode comprises a lithium-containing nickel layered oxide comprising 50 mol % or more of Ni with respect to Li, wherein the negative electrode comprises a stacked body comprising a metal base material layer which does not alloy with lithium and an Al activation layer that is joined to one side or both sides of the metal base material layer, wherein at least a surface side of the Al activation layer has formed a Li—Al alloy.

2. The nonaqueous electrolyte liquid battery according to claim 1, wherein the lithium-containing nickel layered oxide is represented by general composition formula (1); Li₁₊ₓNi_{1-y-z}M¹_{y}M²_{z}O₂ (1) (wherein in the general composition formula (1), M¹ represents at least one kind of elements selected from the group consisting of Co, Mn, Al, Mg, Zr, Mo, Ti, Ba, W and Er, and M² represents an element other than Li, Ni and M¹, and −0.1≤x≤0.1, 0≤y≤0.5, 0≤z≤0.05).

3. The nonaqueous electrolyte liquid battery according to claim 1, wherein a ratio of the lithium-containing nickel layered oxide in the positive electrode active material that the positive electrode includes is 50 mass % or more.

4. The nonaqueous electrolyte liquid battery according to claim 1, wherein the metal base material layer which does not alloy with Li is constituted by one selected from the group consisting of Cu, Ni, Ti and Fe, and its alloy.

5. The nonaqueous electrolyte liquid battery according to claim 1, wherein a thickness of the metal base material layer is 10 to 50 μm.

6. The nonaqueous electrolyte liquid battery according to claim 1, wherein the nonaqueous electrolyte liquid comprises a phosphoric acid compound including a group represented by general formula (2) in its molecule; 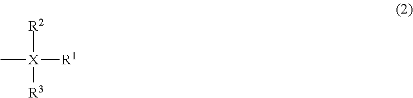
(in which in the general formula (2), X represents Si, Ge or Sn; R¹, R² and R³ each independently represent an alkyl group having a carbon number of 1 to 10, an alkenyl group having a carbon number of 2 to 10, and an aryl group having a carbon number of 6 to 10, in which a part or all of hydrogen atoms thereof are optionally substituted with fluorine).

7. The nonaqueous electrolyte liquid battery according to claim 6, wherein the nonaqueous electrolyte liquid comprises tris(trimethylsilyl) phosphate as the phosphoric acid compound having the group represented the general formula (2) in its molecule.

8. The nonaqueous electrolyte liquid battery according to claim 1, wherein the nonaqueous electrolyte liquid includes LiBF₄ as the lithium salt, and a propylene carbonate as the organic solvent, along with a nitrile compound.

9. The nonaqueous electrolyte liquid battery according to claim 8, wherein the nitrile compound included in the nonaqueous electrolyte liquid is selected from the group consisting of suberonitrile, pimelonitrile and adiponitrile.

10. The nonaqueous electrolyte liquid battery according to claim 8, wherein the nonaqueous electrolyte liquid used therein includes the nitrile compound at a content of 0.1 to 10 mass %.

11. The nonaqueous electrolyte liquid battery according to claim 2, wherein the metal base material layer which does not alloy with Li is constituted by one selected from the group consisting of Cu, Ni, Ti and Fe, and its alloy.

12. The nonaqueous electrolyte liquid battery according to claim 2, wherein a thickness of the metal base material layer is 10 to 50 μm.

13. The nonaqueous electrolyte liquid battery according to claim 6, wherein the nonaqueous electrolyte liquid includes LiBF₄ as the lithium salt, and a propylene carbonate as the organic solvent, along with a nitrile compound.
